(19) United States
(12) Patent Application Publication
(10) Pub. No.: US 2009/0230886 A1
(43) Pub. Date: Sep. 17, 2009

(54) DRIVER DEVICE THAT STABILIZES CURRENT AND AUTOMATICALLY REGULATES VOLTAGE OF A LIGHT EMITTING DIODE

(76) Inventors: Chien-Hsin CHUNG, Taipei City (TW); Dison Hu, Taipei City (TW)

Correspondence Address: Muncy, Geissler, Olds & Lowe, PLLC, P.O. BOX 1364, FAIRFAX, VA, 22038-1364, US

(21) Appl. No.: 12/403,177

(22) Filed: Mar. 12, 2009

(30) Foreign Application Priority Data
Mar. 17, 2008 (TW) 097204581

(51) Int. Cl. H05B 37/02

(52) U.S. Cl. 315/297

(57) ABSTRACT

A driver device that stabilizes current and automatically regulates voltage of a light emitting diode is capable of automatically regulating the voltage and stabilizing the current in accordance with a voltage demand, so as to provide the proper voltage and the stable current, for being applied to control color and shading of the light emitting diode. According to the actual voltage required by the light emitting diode, a current control unit controls a current-controlled transistor to output the stable current, so as to fit with the actual voltage requirement and stably control the changes of color and shading. Therefore, the requirements of energy saving, of that multiple light emitting diodes can be fitted with at a same time, and of that operating temperature can be decreased, are achieved.

### BACKGROUND OF THE INVENTION

a) Field of the Invention

The present invention relates to a driver device that stabilizes current and automatically regulates voltage of a light emitting diode. The driver device provides for an application to control modulation of color and shading of the light emitting diode, and more particularly to a current stabilizing and automatic voltage regulating device which can automatically detect a change of operating voltage of the light emitting diode, and automatically regulate the voltage according to the change, so as to enable the light emitting diode to be more stable when illuminating.

b) Description of the Prior Art

Referring to FIG. 1, it shows a schematic view of an implementation of a conventional light emitting diode driver device, wherein when the light emitting diode is implemented, a driver IC (Integrated Circuit) 10 is utilized primarily to drive a light emitting diode 11 to operate with voltage, such as illuminating; or modulation of input voltage is utilized to drive a plurality of light emitting diodes at a same time to produce a variation of different colors, such as that for the multi-chip light emitting diodes, the voltage change is utilized to enable each light emitting diode to produce a different color, thereby achieving an effect of color mixing. During the driving process, a demand of stabilizing the output voltage is primarily to allow the light emitting diode 11 to produce the stable color. However, in a real implementation, the issue of unstable illuminating still arises. The major reason lies in that the light emitting diode is very sensitive to electricity that although the input voltage can be controlled to be at a constant state, composition of materials that make the light emitting diode and a packaging process will all affect the demand to the voltage. Therefore, in the implementation of an ordinary light emitting diode, a positive and a negative value of the voltage demand will be marked usually; that is, the light emitting diode is driven by the proper voltage within the range between the positive and negative values of the ideal demand of voltage. When a single light emitting diode 11 is driven by the voltage, the condition is more stable. Yet, when multiple light emitting diodes 11 are connected serially (as shown in the drawing) or parallel for use at a same time, even that they are driven by the required voltage, the unstable illuminating state will be resulted due to this voltage difference and the instability of current that passes through the light emitting diodes. Moreover, when the voltage difference differs from the driving voltage significantly, temperature of the light emitting diodes will rise. In addition, for the conventional driving method, the input voltage cannot be regulated dependent upon the voltage difference, which will cause waste of energy and accelerate optical attenuation of the light emitting diodes, thereby affecting a lifetime of usage of the light emitting diodes.

### SUMMARY OF THE INVENTION

Accordingly, the primary object of the present invention is to provide a driver device that stabilizes current and automatically regulates voltage of a light emitting diode. The driver device can effectively drive the light emitting diode, provide the stable matching current and automatically regulate the voltage according to the voltage demand, assure the stability of illumination, as well as comply with the requirements of energy saving and controlling temperature rise and voltage change.

To achieve the aforementioned object, the present invention utilizes primarily a current control unit to control stable current that the light emitting diode requires, further detecting a voltage drop of a current-controlled transistor to modulate input voltage automatically, so that the requirement of real voltage can be matched to cope with a voltage change resulted from all kinds of light emitting diodes that are connected serially or temperature rise, and to stably control the current that needs to pass through, through the current-controlled transistor, thereby stably controlling changes of color and shading. The present invention can further match with an LED (Light Emitting Diode) quantity detection & auto voltage control unit to detect the voltage required by the light emitting diode. After a reference voltage is outputted through a band-gap generator, the voltage control unit can correspond more accurately with the actual voltage required by the light emitting diode to fit with the demand of the actual voltage, thereby complying with the energy saving, being able to match with multiple light emitting diodes at a same time and reducing operating temperature.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an implementation of a conventional light emitting diode driver device.

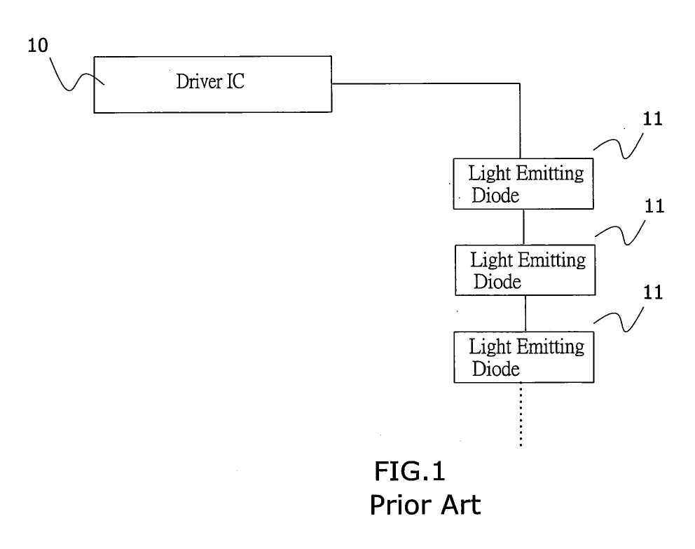

FIG. 2 shows a schematic view of components of the present invention.

FIG. 3 shows a schematic view of another preferred embodiment of the present invention.

FIG. 4 shows a schematic view of a wiring layout of units constituting an embodiment of the present invention.

### DETAILED DESCRIPTION OF THE PREFERRED EMBODIMENTS

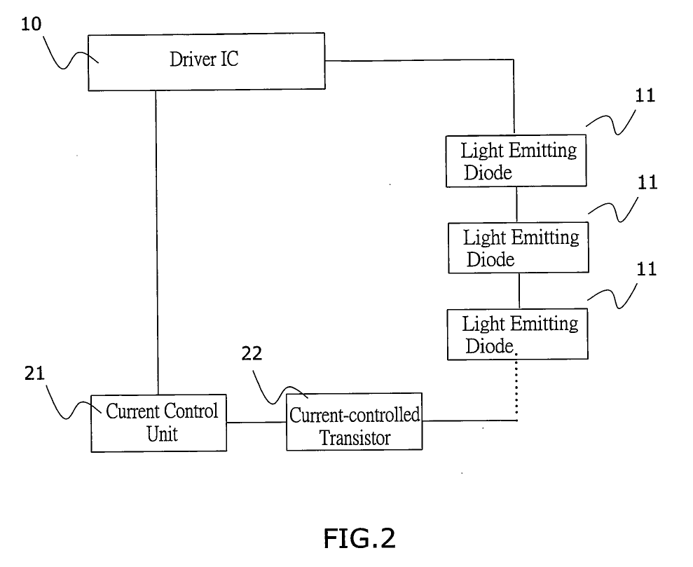

Referring to FIG. 2, it shows a schematic view of components of the present invention, wherein a driver device that stabilizes current and automatically regulates voltage of a light emitting diode comprises primarily a current control unit 21 and a current-controlled transistor 22. The current control unit 21 is electrically connected by a circuit wiring with the current-controlled transistor 22, and the current control unit 21 can control current outputted from the current-controlled transistor 22, allowing the output current to be stabilized at a specific value, so as to cope with and comply with an actual voltage demand of light emitting diodes 11. As shown in the drawing again, when laying out the wiring, the current-controlled transistor 22 is electrically connected to the light emitting diodes 11, and the current control unit 21 is electrically connected with an existing driver IC 10. When the driver IC 10 outputs required voltage to the light emitting diodes 11, the current control unit 21 can modulate the stable current that meets the requirement and a stable current control can be performed by the current-controlled transistor 22. This function cannot be achieved by the conventional driver IC 10.

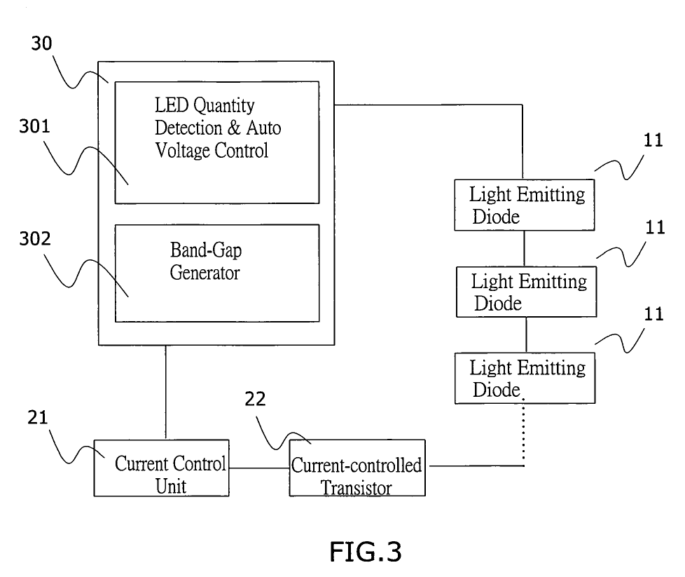

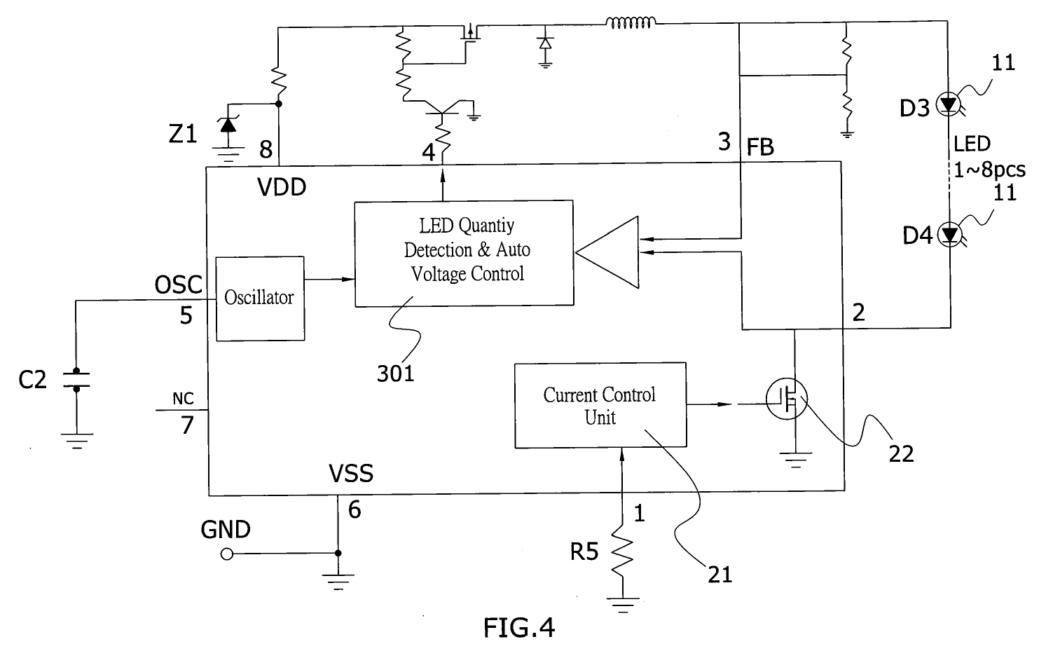

Referring to FIG. 3, it shows a schematic view of another preferred embodiment of the present invention (in association with FIG. 4, which shows a schematic view of a wiring layout of units constituting an embodiment of the present invention). A current control unit 21 can be also connected with a driver IC 30 that is constituted by an LED quantity detection & auto voltage control unit 301 and a band-gap generator 302, wherein after the LED quantity detection & auto voltage control unit 301 has detected a quantity of the light emitting diodes 11 and the actual voltage demand, the band-gap generator 302 produces the actual voltage demand, and then the actual voltage that goes to the current-controlled transistor 22 is fed back by the current control unit 21. If that voltage demand is too low, then the voltage will be increased automatically. On the other hand, if the voltage demand is higher than a certain value, then the voltage will be decreased. Referring to FIG. 4, the voltage drop through the detecting the current-controlled transistor 22 is fed back to the LED quantity detection & auto voltage control unit 301 to control the output voltage that when the output voltage is too low, the voltage will be increased automatically, and when the output voltage is higher than a certain value, the voltage will be decreased. Therefore, the voltage that drives each light emitting diode 11 will be kept at a dynamic state and at a voltage value that is just enough. Accordingly, there will be no waste of too high the voltage, and the light emitting diodes 11 can be assured to work under the proper operating voltage and temperature, thereby complying with the requirements of energy saving and environmental protection.

Accordingly, after the present invention has been implemented, the voltage control unit can automatically modulate the fitted voltage, and the current-controlled transistor can control the stable current, according to the actual number of light emitting diodes that are connected serially (or parallel) and the actual voltage demand, such that the light emitting diodes can operate more stably. Therefore, the auxiliary device for driving the light emitting diode, that can effectively drive the light emitting diode, can automatically detect the voltage demand and provide the stable current, as well as can assure the stability of illumination, is actually provided.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A driver device that stabilizes current and automatically regulates voltage of a light emitting diode, being electrically connected at more than one light emitting diode and provided with functions of automatically regulating the voltage and stabilizing the current in accordance with a voltage demand, comprising a current control unit which is used to modulate input current, and a current-controlled transistor which is connected between the light emitting diodes and the current control unit to control current stably according to the value of the input current.

2. The driver device that stabilizes current and automatically regulates voltage of a light emitting diode, according to claim 1, wherein a driver IC (Integrated Circuit) is electrically connected between the current control unit and the light emitting diodes.

3. The driver device that stabilizes current and automatically regulates voltage of a light emitting diode, according to claim 2, wherein the driver IC is constituted by an LED (Light Emitting Diode) quantity detection & auto voltage control unit, a band-gap generator and another current-controlled transistor.

4. The driver device that stabilizes current and automatically regulates voltage of a light emitting diode, according to claim 3, wherein a detected voltage drop of the current-controlled transistor is fed back to the LED quantity detection & auto voltage control unit to control output voltage that if the voltage is too low, then the voltage is increased automatically, or if the voltage is higher than a certain value, then the voltage is decreased, so as to keep the voltage that drives the light emitting diode at a dynamic state and at a value that is just enough.
